(19) United States
(12) Patent Application Publication
(10) Pub. No.: US 2009/0309375 A1
(43) Pub. Date: Dec. 17, 2009

(54) Automatic Gate Lock

(76) Inventor: Yuri Uryasov, Garfield, NJ (US)

Correspondence Address: WOLFF & SAMSON, P.C., ONE BOLAND DRIVE, WEST ORANGE, NJ, 07052, US

(21) Appl. No.: 12/545,193

(22) Filed: Aug. 21, 2009

Related U.S. Application Data
(62) Division of application No. 11/516,977, filed on Sep. 7, 2006, now abandoned.

(51) Int. Cl. E05C 1/12

(52) U.S. Cl. 292/173

(57) ABSTRACT

An automatic gate opener lock. The gate opener lock has a locking bolt which is moved between locked and unlocked positions by the movement of a swing arm of an automatic gate opener. To prevent movement of the locking bolt toward its locked position before the gate is closed, springs are arranged for resisting movement in that direction. The springs have a combined resistive force greater than the force required to move the gate. Only when the gate is closed, and the force from the swing arm may no longer be dissipated through gate movement, is the combined force of the springs overcome, and the locking bolt moved into the locked position.

### BACKGROUND OF THE INVENTION

1. Field of the Invention

The present invention relates to remotely controlled devices for controlling access through gates and doors.

2. Discussion of the Background Art

Devices for remotely opening and closing gates and doors are known in the art, as are devices for remotely locking gates and doors. Presently, electrically operated gate opening and closing devices are in widespread use. These gate opening and closing devices are of limited use for preventing persons from entering or exiting, because the devices do not actually lock the free-swinging end of the gate adjacent to the fence post. Therefore, particularly with a wide gate which may be easily bent, a person may merely push or pull the free-swinging edge of a closed gate enough to pass through. Separate remotely-controlled locking devices are often installed on such gates to solve this problem. A person requiring remotely controlled opening, closing, and locking will, therefore, be forced to purchase a rather expensive remotely controlled locking device in addition to the likewise expensive remotely-controlled gate opening and closing device.

It would be advantageous to devise a simple and inexpensive apparatus which adapts existing gate opening and closing devices to lock the free-swinging end of the gates or doors on which the devices are installed.

### SUMMARY OF THE INVENTION

An automatic gate opener lock. The gate opener lock has a locking bolt which is moved between locked and unlocked positions by the movement of swing arm of an automatic gate opener. To prevent movement of the locking bolt toward its locked position before the gate is closed, a spring is arranged for resisting movement in that direction. The spring has a resistive force greater than the force required to move the gate. Only when the gate is closed, and the force from the swing arm may no longer be dissipated through gate movement, is the force of the spring overcome, and the locking bolt moved into the locked position.

Further advantages, features and details of the invention are revealed in the following description of preferred exemplified embodiments and with the aid of the drawings.

### BRIEF DESCRIPTION OF THE DRAWINGS

FIG. 1 shows the locking apparatus mounted on a swinging outdoor gate.

FIG. 2 shows a top view of the locking apparatus mounted on a swinging outdoor gate.

FIG. 2a shows an alternate view of the rod mount.

FIG. 3 shows an alternate embodiment of the locking apparatus mounted on a swinging outdoor gate.

FIG. 4 is an enlarged view of the alternate embodiment of the locking apparatus in FIG. 3.

FIG. 5 shows a second alternate embodiment of the locking apparatus.

FIGS. 6a and 6b show enlarged views of the second alternate embodiment of the locking apparatus.

### DETAILED DESCRIPTION OF THE INVENTION

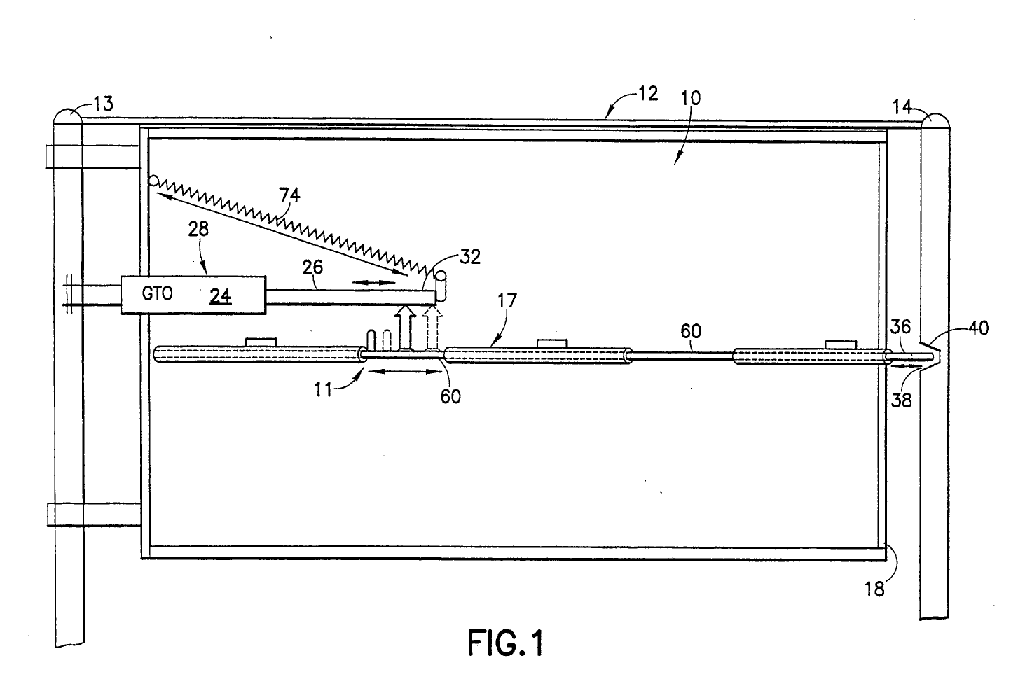

The present invention comprises a locking apparatus for an automatic gate Referring to FIG. 1, the system consisting of the opening and closing device and the locking apparatus is referred to generally by the reference numeral 10. The locking apparatus is referred to by the reference numeral 11. The system 10 is shown installed on an outdoor fence having a radially-swinging gate 12. The gate 12 lies between two stationary posts, 13 and 14. The jamb post 14 stands adjacent to the swinging edge 18 of the gate 12. The support post 13 stands adjacent to and supports the pivotal end 22 of gate 12. The gate opener 24 is shown mounted to the post 13.

Referring again to FIG. 1, the gate opener 24 has a swing arm 26 attached to or provided as a piston of a cylinder 28. When the gate 12 is to be closed, the gate opener 24 is activated and the swing arm 26 travels radially in a direction which pushes the gate 12 toward its closed position. As the swing arm 26 travels, the piston extends outwardly toward the swinging edge 18 of the gate 12. The gate opener 24 is designed so that the piston continues to extend after the gate 12 reaches a fully closed position. The extension stops when a pre-determined tension is reached. When the gate 12 is to be opened, the process is reversed with the piston retracting and the swing arm 26 traveling radially in the reverse direction.

Without the addition of the locking apparatus 11, the distal end 32 of the swing arm 26 is typically attached directly to the gate 12. Here, the distal end 32 of the swing arm 26 is pivotally attached to a bar 15. The bar 15 is mounted inside a tube 17 so that the bar 15 may move a certain distance in the tube. The extension of the arm 26 after the gate 12 is closed, as mentioned above, usually only creates tension on the gate 12 to help hold it in its closed position. The present invention uses this after-closing movement to move the bar 15 between an extended-locked position and a retracted-unlocked position. In the extended-locked position, a distal end 36 of the bar 15 extends through a hole 38 of a bolt receiver 40. The bolt receiver 40 is mounted on the post 14.

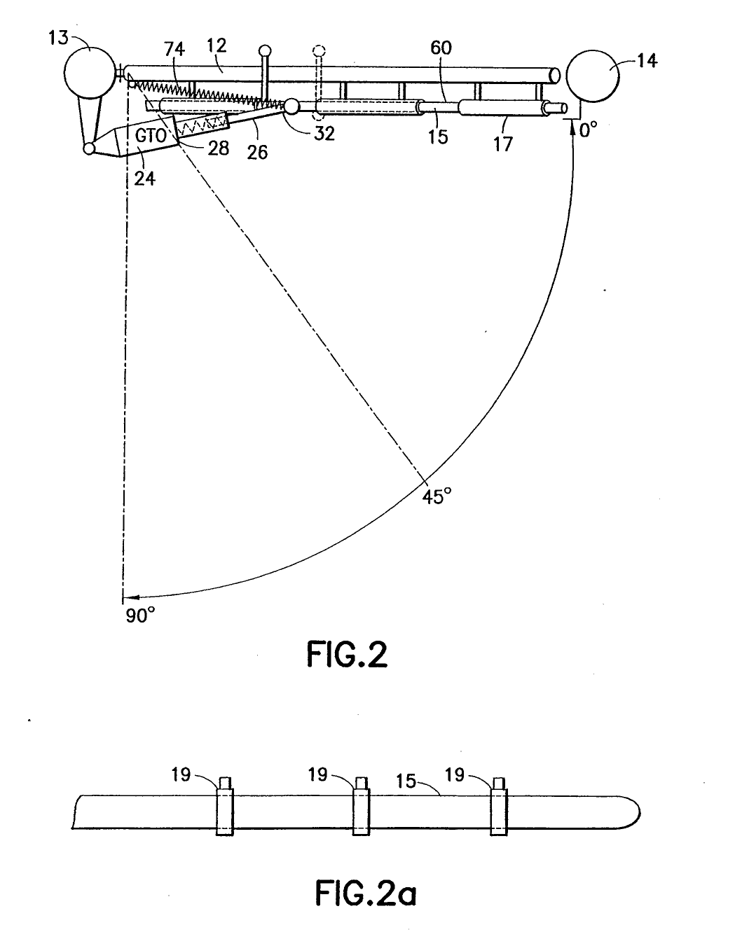

Referring in combination to FIGS. 1, and 2, the tube 17 is attached to the gate 12. The tube 17 serves as a mounting and support platform for the bar 15. The tube 17 of the preferred embodiment is constructed of tubular metal which is attached to the gate 12 so that the tube 17 is horizontally oriented and abuts the gate 12.

Referring again to FIGS. 1, and 2 in combination, the tube 17 has a plurality of slots 60 disposed along its axis. When mounted in this manner, the bar 15, regardless of the direction of force applied to it, may only move, if at all, parallel with the longitudinal axis of the tube 17. The length of the slots 60 of the force tube 17 are such that the bar 15 may move sufficiently to move the bar 15 between its locked and unlocked positions; that is, to move the distal end 36 in and out of the hole 38 in the bolt receiver 40.

FIG. 2a shows an alternate embodiment of attaching the bar 15 to the gate 12. The bar 15 is mounted inside rings 19 so that the bar 15 may move a certain distance. This cuts down on friction with the bar 15 and keeps debris and ice from forming in the tube 17, while keeping the bar 15 from moving. The rings 19 are attached to the gate 12. The rings 19 serve as a mounting and support platform for the bar 15. The rings 19 are constructed of, for example, circular metal and are attached to the gate 12 so that the rings 19 are horizontally oriented and abut the gate 12. When mounted in this manner, the bar 15, regardless of the direction of force applied to it, may only move, if at all, parallel with the central axis of the rings 19. The position of the rings 19 is such that the bar 15 may move sufficiently to move the bar 15 between its locked and unlocked positions; that is, to move the distal end 36 in and out of the hole 38 in the bolt receiver 40.

The bar 15 is, in the preferred embodiment, a rod-like member. The length of the bar 15 is determined by the width of the gate 12. As the swing arm 26 pushes against the bar 15 while the gate 12 is being closed, the bar 15 tends to move toward the swinging edge 18 of the gate 12, and consequently tends to push the bar 15 toward its locked position. A mechanism is necessary for preventing extension of the bar 15 before the gate 12 is fully closed. The preferred embodiment of the present invention includes a spring to accomplish this.

A spring 74 has one end attached to an edge of the gate adjacent the support post 13, and another end connected to the distal end 32 of the swing arm 26 or the bar 15. In this configuration, the spring 74 resists movement of the bar 15 toward its locked position. The resistance of the spring 74 to stretching exerts a force against the extension of the distal end 36 toward its locked position slightly greater than the force required to move the gate 12 toward its closed position. Therefore, before the gate 12 is fully closed, when the force exerted by the cylinder 28 may be dissipated through movement of the gate 12, the distal end 36 remains in its retracted-unlocked position. Only when the gate 12 is fully closed and the force exerted by the cylinder 28 may no longer be dissipated by movement of the gate 12, is the combined resistive force of the spring 74 overcome allowing the distal end 36 to extend into its locked position. The spring 74 pulls the gate closed ahead of the force exerted by the cylinder 28, keeping the bar 15 in a retracted position. When the gate 12 reaches its stopping point, the force of the spring 74 is overcome by the cylinder 28, and the bar 15 is moved into the locking position.

Operation of the gate opener 24 having the locking apparatus 11 added is, from a user's standpoint, no different than without the locking apparatus 11; a user merely actuates the remote control (not shown) of the gate opener 24. When the gate 12 is open, the gate opener 24 responds by moving the swing arm 26 in a direction which pushes the gate 12 closed. As the swing arm 26 moves it gradually extends from the cylinder 28. The extension of the swing arm 26 and, to a lesser extent, the radial movement of the swing arm 26 in certain positions, tend to move the force bar 15 toward its locked position. Because of the spring 74 as above described, the forces exerted on the bar 15 are translated instead into movement of the gate 12. When the gate 12 may no longer move toward its closed position, whether by fully closing or by reaching an obstruction which prevents it from moving further, the resistive forces of the spring 74 are overcome and the bar 15 extends into its locked position. When properly closed, the distal end 36 of the bar 15 extends into the hole 38 of the bolt receiver 40 thereby locking the gate 12.

When the gate 12 is to be opened, the user again actuates the remote control (not shown). The swing arm 26 retracts into the cylinder 28, the bar 15 pulls the distal end 36 from the hole 38 of the bolt receiver 40, and the gate 12 is then free to swing open under force from the cylinder 28 and the swing arm 26.

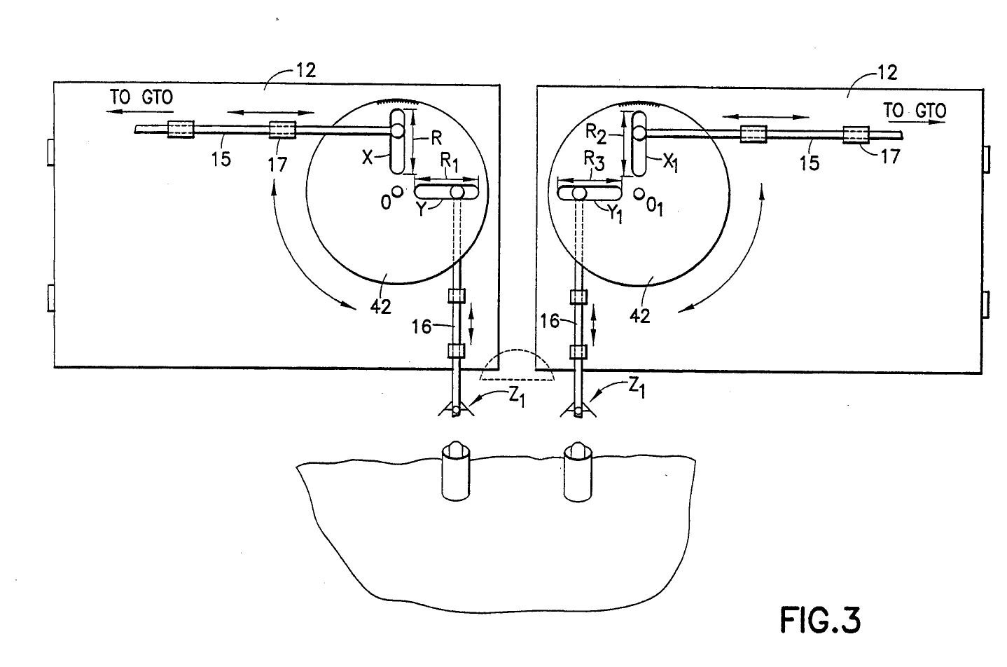

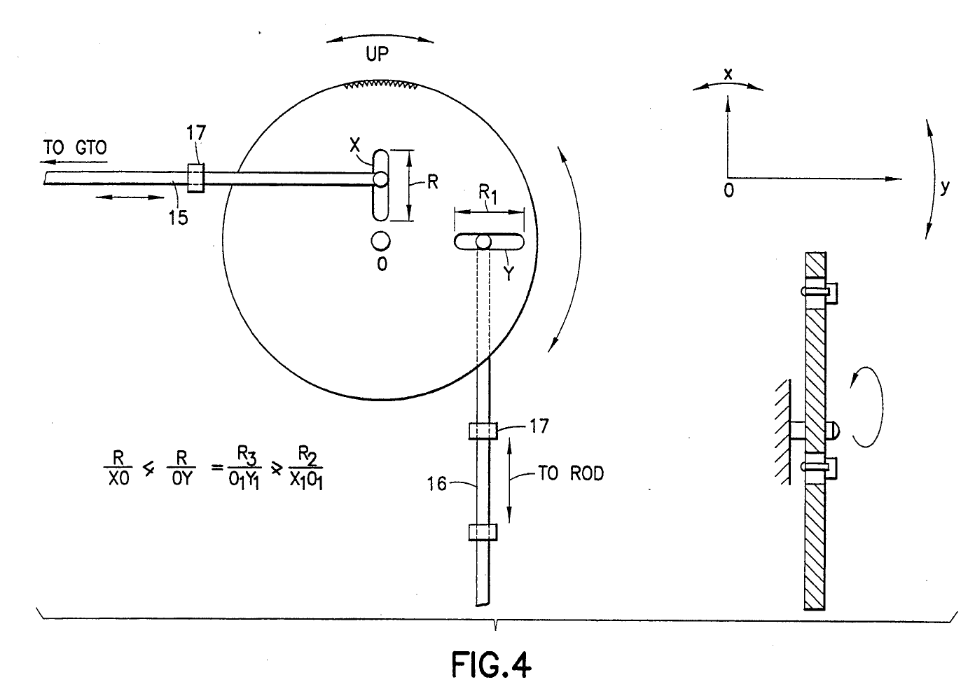

Referring to FIGS. 3, and 4, an alternative embodiment of the present invention includes a locking apparatus 11 which accommodates two gates 12. Although described in connection with two gates the system can also be used with a single gate. The bars 15 are attached to flat disks 42. The flat disks 42 have a slot x in which an end of the bar 15 is slidably arranged. Disks 42 also have a slot y, in which an end of a second locking bar 16 is slidably arranged. The distance from the center of disk 42 to the slot x is less than the distance from the center of disk 42 to the slot y.

When the gate 12 is closed, and the spring force is overcome, as discussed above, the bar 15 begins to exert force on the disk 42 by pressing on the wall of the slot x. When this happens, the disk 42 begins to rotate, exerting force, via the slot y, on the bar 16, forcing it in a downward, into a receiver (not shown) located beneath the gate 12. When the gate 12 is opened, force is exerted by the bar 15 on the slot x of disk 42, thereby causing the disk 42 to rotate. The disk 42 then exerts force on the bar 16 via the slot y, pulling the rod 16 in an upwards direction and thereby releasing the lock.

In the same manner as with the previous embodiment, the bar 16 does not extend until the force from the swing arm 26 may no longer be dissipated through movement of the gate 12. When the swing arm 26 moves to open the gate 12, the bar 16 retracts under force from the spring 74.

Although the above embodiment is described with the bar 16 extending downwardly, it is also possible to have the bar 16 extend upwardly to engage in a receiver mounted above the gate.

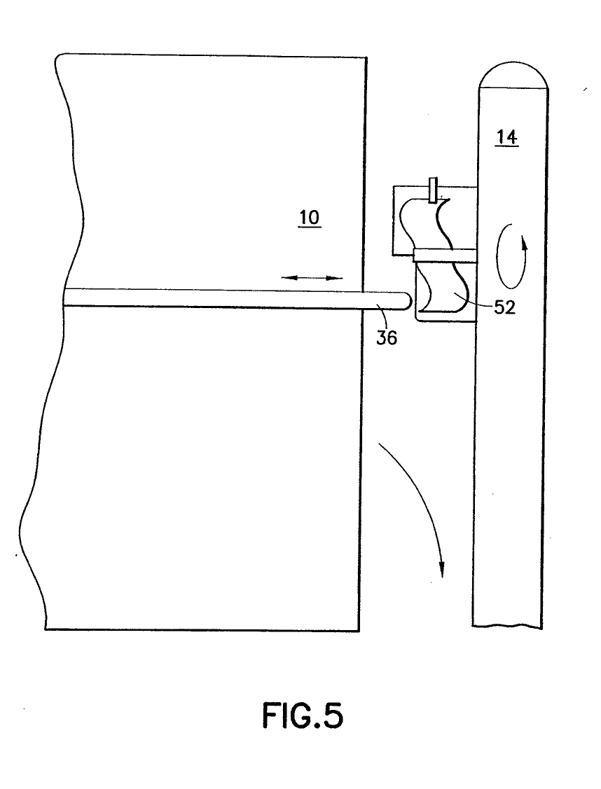

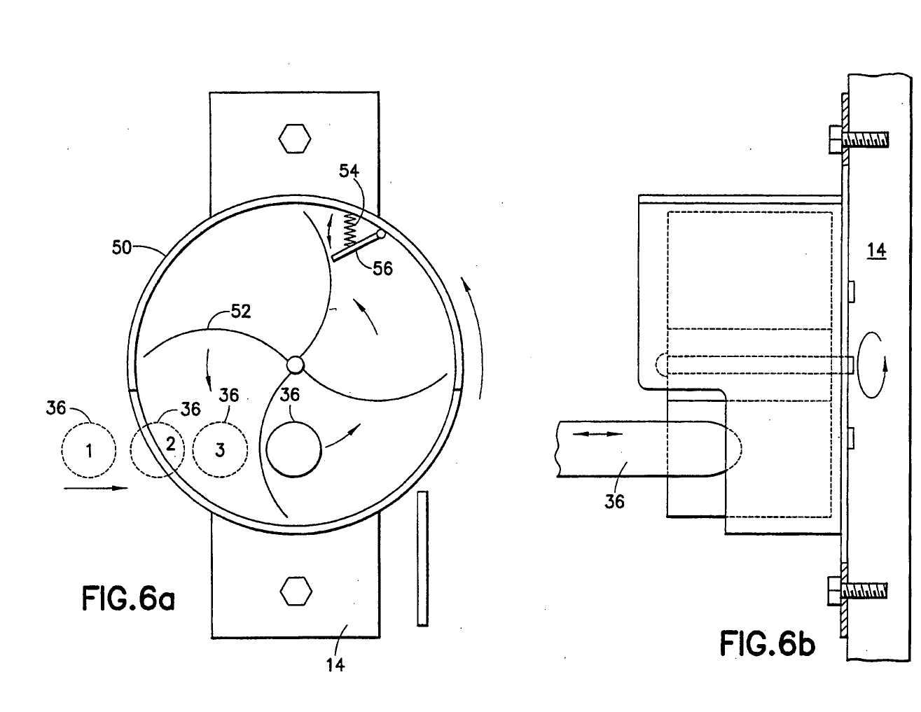

Referring to FIGS. 5, and 6, another embodiment of the present invention includes a locking apparatus 50 which is attached to the post 14. The locking apparatus 50 is comprised of a propeller 52, a spring 54 and a stopper 56. When the gate 12 is being closed, as described above, wind or some other force may cause the gate to be pushed closed with less force than normal, causing the gate to be closed with lock rod 36 extended.

When this happens, the gate 12 is closed, and the bar 15 is extended, and the end 36 meets one of the blades of the propeller 52. The propeller 52 is allowed to turn in a counter clockwise direction by the spring 54 and the stopper 56, until the gate 12 is in the closed position, but is not allowed to turn in a clockwise direction, releasing the gate, so the gate remains locked.

When gate 12 is opened, force is exerted on the bar 15 thereby causing the end 36 of the rod to be pulled out of the locking apparatus 50, allowing the gate to open. In the same manner as previously described, the swing arm 26 moves to open the gate 12, which allows the bar 15 to retract under force from the spring 74.

The locking apparatus 50 can be utilized in combination with the bolt receiver 40 or in place of the bolt receiver.

Although described in connection with a gate, the inventive locking mechanism is equally applicable to a wide variety of systems ranging from doors to hospitals to aircraft landing gear. Basically, the invention can be used in virtually any system where a structure can be moved between at least two positions and needs to be locked in an end position.

While the invention has been described in connection with the preferred embodiment, it is not intended to limit the invention to the particular forms or practices set forth, but, on the contrary, it is intended to cover such alternatives, modifications, and equivalents as may be included within the spirit and scope of the invention as defined as the appended claims.

1-6. (canceled)

7. A locking apparatus for a swinging gate having a swing arm powered gate opener wherein the swing arm exerts a first force substantially perpendicular to a face of the gate for moving the gate toward a closed position and exerts a second force substantially perpendicular to the gate face for moving the gate toward an open position, comprising:
a locking bolt slidably supported on the swinging gate so as to be movable between an extended position for engaging bolt receiving means and a retracted position;
force directing means mounted on the gate, said force directing means having a disk operatively engaged to direct the first and second force substantially vertically, from said swing arm to said locking bolt;
resisting means engaged with the locking bolt and the gate so as to prevent extension of the locking bolt prior to the gate reaching the closed position, said force directing means being mounted so that the swing arm moves said force directing means, and said force directing means moves said locking bolt between said extended and said retracted positions, the first force being substantially dissipated through movement of the gate toward said closed position until the gate reaches said closed position, the first force overcoming a spring force of the resisting means and extending said locking bolt when said first force is no longer dissipated through movement of the gate.

8. The locking apparatus according to claim 7, wherein the resisting means comprises a spring engaging said gate and said locking bolt so that said spring must be stretched for said locking bolt to extend toward said extended position.

9. The locking apparatus according to claim 7, wherein said resisting means comprises a spring, said spring force being greater than the first force required to move the gate toward the closed position.

10. The locking apparatus according to claim 9, further comprising an abutment arranged so as to limit travel of said locking bolt.

11. The locking apparatus according to claim 10, further comprising a locking mechanism operative to lock the gate when the gate is closed with said locking bolt extended.

12. The locking apparatus according to claim 11, wherein said locking mechanism comprises a propeller which is allowed to move in only one direction so as to capture the extended locking bolt and lock the gate in place.

13-19. (canceled)
